(19) United States
(12) Patent Application Publication
(10) Pub. No.: US 2026/0183180 A1
(43) Pub. Date: Jul. 2, 2026

(54) STIMULATION DEVICE INCLUDING CONTACT-MAINTAINING STIMULATION COMPONENT

(71) Applicant: HYTTO PTE. LTD., Singapore (SG)

(72) Inventors: Dan Liu, Guangdong (CN); Jilin Qiu, Guangdong (CN); Zhiwen Wu, Guangdong (CN); Junhua Feng, Guangdong (CN)

(21) Appl. No.: 19/260,881

(22) Filed: Jul. 7, 2025

Related U.S. Application Data
(63) Continuation-in-part of application No. 19/006,668, filed on Dec. 31, 2024.

(51) Int. Cl. A61H 19/00; A61H 23/02

(52) U.S. Cl. CPC A61H 19/34; A61H 19/44; A61H 23/02; A61H 2201/1253; A61H 2201/169

(57) ABSTRACT

A sexual stimulation device includes a handle. A first stimulation component is extended from the handle and is configured to be inserted into a bodily orifice. A second stimulation component has a stimulation end that is configured to stimulate an erogenous zone that is proximate to the bodily orifice. A coupling mechanism is configured to couple the second stimulation component to the handle. The coupling mechanism includes a sliding pair configured to define a motion trajectory of the stimulation end and a resilient element configured to store or release potential energy as the stimulation end moves, such that the stimulation end maintains continuous contact with the erogenous zone as the first stimulation component reciprocates within the bodily orifice.

### CROSS REFERENCE TO RELATED APPLICATION

This application is a Continuation-in-Part of co-pending U.S. patent application Ser. No. 19/006,668, filed on Dec. 31, 2024, the entire contents of which are herein incorporated by reference.

### TECHNICAL FIELD

The present disclosure relates to a stimulation device and, more specifically, to a stimulation device including a contact-maintaining stimulation component.

### DISCUSSION OF THE RELATED ART

Sexual stimulation devices have been developed to include a pair of stimulation components with the first stimulation component designed for bodily penetration and the second stimulation component designed for external stimulation. For example, a first stimulation component may be designed to be inserted into the vagina while the second stimulation component is designed to remain in contact with the clitoris. Such devices generally made use of a single hinge arrangement connecting the second stimulation component to the main body of the device so that as the first stimulation component is repeatedly inserted and removed, the second stimulation component is free to maintain a relatively constant position at the clitoris by the movement of the hinge.

However, this single hinge arrangement may give rise to unstable movement of the second stimulation component that may be prone to wobble laterally instead of reliably tracking the clitoris, thereby reducing the effectiveness of the device to provide the desired degree of sexual stimulation.

### SUMMARY

A sexual stimulation device includes a handle. A first stimulation component is extended from the handle and is configured to be inserted into a bodily orifice. A second stimulation component has a stimulation end that is configured to stimulate an erogenous zone that is proximate to the bodily orifice. A coupling mechanism is configured to couple the second stimulation component to the handle. The coupling mechanism includes a sliding pair configured to define a motion trajectory of the stimulation end and a resilient element configured to store or release potential energy as the stimulation end moves, such that the stimulation end maintains continuous contact with the erogenous zone as the first stimulation component reciprocates within the bodily orifice.

The stimulation end may be constrained to move in a first direction along the motion trajectory while maintaining continuous contact with the erogenous zone when the first stimulation component is inserted into the bodily orifice, thereby causing the resilient element to store potential energy. The stimulation end may be constrained to move in a second direction, opposite to the first direction, when the first stimulation component is withdrawn from the bodily orifice by the release of the stored potential energy from the resilient element, thereby maintaining continuous contact between the stimulation end and the erogenous zone.

The coupling mechanism may further include a flexible covering, at least a portion of the flexible covering forming an elastic region. The resilient element may be defined by the elastic region.

The sliding pair may include a guide formed by at least a portion of the handle and a slide coupled to the second stimulation component and configured to slide along the motion trajectory.

The sliding pair may be disposed within the handle or within the second stimulation component.

The guide may include an elongate rod. The slide may include a sleeve accommodated about the elongate rod. The sleeve may be connected to the second stimulation component.

The resilient element may be a helical spring wound about the elongate rod, with opposite ends of the helical spring respectively connected to the sleeve and the handle.

The guide may include an elongate hole formed on the handle, and the slide may include a protrusion extending through the elongate hole.

The resilient element may include a helical spring disposed within the handle, with opposite ends of the helical spring respectively connected to the protrusion and the handle.

The guide may include an elongate groove, and the slide may include a key engaged within the elongate groove.

The motion trajectory of the stimulation end may correspond to a reciprocating trajectory of the first stimulation component during reciprocation.

The guide may include a sleeve, the slide may include an elongate rod about which the sleeve is circumscribed, and the elongate rod may be connected to the second stimulation component.

The sliding pair may be a curved sliding pair, and the motion trajectory may be an arcuate trajectory.

The motion trajectory of the stimulation end may be substantially confined to a two-dimensional plane.

A contact surface between the stimulation end and the erogenous zone may remain substantially unchanged as the first stimulation component reciprocates within the bodily orifice.

A sexual stimulation device includes a main body including a handle and a first stimulation component. The first stimulation component is configured to be inserted into a bodily orifice. A second stimulation component has a stimulation end configured to provide sexual stimulation to an erogenous zone that is proximate to the bodily orifice. A coupling mechanism couples the second stimulation component to the main body. A sliding pair is configured to define a motion trajectory of the stimulation end. A resilient element is configured to store or release elastic potential energy as the stimulation end moves, such that the stimulation end maintains continuous contact with the erogenous zone as the first stimulation component reciprocates within the bodily orifice.

The sliding pair may include a guide including at least a portion of the coupling mechanism and a slide including at least a portion of the second stimulation component, the slide configured to slide along the motion trajectory.

The guide may include a sleeve including at least a portion of the coupling mechanism. The slide may include an elongate rod formed by at least a portion of the second stimulation component. The elongate rod may pass through the sleeve.

The motion trajectory may be parallel to the reciprocating trajectory of the first stimulation component.

A sexual stimulation device includes a main body, at least a portion thereof forming a first stimulation component, the first stimulation component configured to be inserted into a bodily orifice. A second stimulation component has a stimulation portion configured to provide sexual stimulation to an erogenous zone that is proximate to the bodily orifice. A coupling mechanism is configured to couple the second stimulation component to the main body. The coupling mechanism includes a first elastic connector and a second elastic connector. The stimulation portion has a first end and a second end, and the first and second elastic connectors are respectively connected to the first and second ends, converging at the main body to form an annular space. The annular space is configured to deform as the first stimulation component is inserted into and is withdrawn from the bodily orifice, such that the stimulation portion maintains continuous contact with the erogenous zone during insertion and withdrawal.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a plan view of a stimulation device, illustrated in an extended state, in accordance with exemplary embodiments of the present invention;

FIG. 2 is a plan view of the stimulation device in a contracted state;

FIG. 3 is a perspective view of the stimulation device in an extended state;

FIG. 4 is a perspective view of the stimulation device in a contracted state;

FIG. 5 is a cutaway plan view of the stimulation device in an extended state, in accordance with exemplary embodiments of the present disclosure;

FIG. 6 is a cutaway perspective view of a stimulation device in an extended state in accordance with exemplary embodiments of the present disclosure;

FIG. 7 is a plan view of a stimulation device in an extended state in accordance with exemplary embodiments of the present disclosure;

FIG. 8 is a plan view of a stimulation device in an intermediate state, in accordance with an exemplary embodiment of the present disclosure;

FIG. 9 is a plan view of a stimulation device in an extended state in accordance with exemplary embodiments of the present disclosure; and

FIG. 10 is a plan view of a stimulation device having an alternative coupling mechanism in accordance with exemplary embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present disclosure relate to a sexual stimulation device in which there is a first stimulation component configured to be repeatedly inserted into and removed from a bodily orifice of a user, in a reciprocating manner, such as the vagina or anus, while a second stimulation component makes use of a specialized coupling that permits the second stimulation component to maintain a relatively stable location at an exterior of the body of the user, such as at a clitoris or perineum without lateral wobbling of known arrangements.

The reciprocating manner of movement may be provided either by the user manually pushing and pulling upon the device or by an electric reciprocating motor disposed therein.

This specialized coupling may employ such elements as a resilient mechanism, a sliding pair design, and a flexible covering that may be used individually or in combination with one another. The resilient mechanism is a system that stores and releases elastic potential energy such as mechanical potential energy, magnetic potential energy, etc. while reducing undesirable lateral movement.

The sliding pair design guides the second stimulation component along a controlled and predictable path that may be linear, curved, planar, etc., thereby reducing undesirable lateral movement. This path may be referred to herein as a motion trajectory, as it may be a path in three-dimensional space that the second stimulation component is confined to follow both backwards and forwards.

In the present disclosure, a sliding pair—a form of A-type kinematic pair—is employed to constrain the motion of the second stimulation component along a defined path. A sliding pair permits predominantly linear translational movement between two components while restricting rotational motion, thereby limiting the system to a single degree of freedom. This controlled movement path, or motion trajectory, may be linear, curved, or otherwise planar in nature.

The sliding pair may be formed not only between the elongate rod and the sleeve, but also between other corresponding components—for example, between the first stimulation component and an internal guide rail, between the sleeve and an internal track surface, or between a collar and the elongate rod. Regardless of the specific components, such sliding engagement ensures precise, low-friction guidance of the second stimulation component along a controlled path.

Preferably, this motion trajectory is maintained substantially within a single plane, so that the stimulating end of the second stimulation component remains in continuous contact with an external erogenous zone of the human body (e.g., the clitoris) without relative slipping. This structural configuration ensures that, as the first stimulation component performs a reciprocating motion within a bodily orifice (such as the vagina), the second stimulation component follows this motion in synchrony—thereby enabling the stimulating end to deliver continuous, effective stimulation to the external erogenous zone in coordination with the internal reciprocation of the first stimulation component.

Moreover, by employing a sliding pair structure, the stimulation delivered by the second stimulation component to the clitoris is provided in the form of tip stimulation, rather than through a broader head-face (end-face) contact. This design ensures a smaller contact area, which enables greater compressive stress to be applied to the erogenous zone while still maintaining stable and consistent contact. This combination of focused pressure and positional stability enhances the stimulation intensity and precision, offering improved effectiveness over conventional designs that rely on larger contact surfaces.

The flexible covering may provide both protection for the device as well as provide means of storing elastic potential energy that may be combined with internal means for storing elastic potential energy, internal means for storing magnetic potential energy, etc.

By combining one or more of these elements, an improved user experience may be provided that is able to keep consistent stimulation pressure to a more precise anatomical location for better comfort and effectiveness during use.

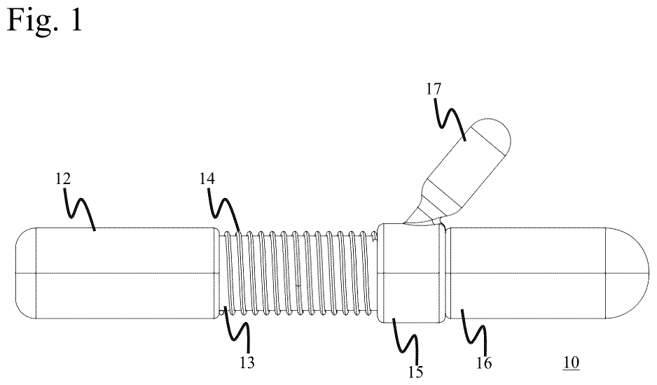

FIG. 1 is a plan view of a stimulation device, illustrated in an extended state, in accordance with exemplary embodiments of the present invention. As can be appreciated from this figure, the stimulation device 10 includes a main body, the main body includes a handle 12 arrange at the bottom thereof, an elongate rod 13 connected thereto in a stationary coupling and a first stimulation component 16 is connected to an opposite side of the elongate rod 13 from the handle 12, also with a stationary coupling. Together, the handle 12 and the first stimulation component 16 may form a main body of the stimulation device 10 and the elongate rod 13 that connects the handle 12 to the first stimulation component 16 may also be considered as part of the main body.

The first stimulation component 16 may be configured to be inserted into a bodily orifice of the user, such as the vagina or anus.

A sleeve 15 may be disposed about the elongate rod 13, coaxially thereto, such that the sleeve may slide backward toward the handle 12 and forward toward the first stimulation component 16 along a motion trajectory which is defined by an axis of the elongate rod 13. While the sleeve 15 may be free to move forward and backward, it may be constrained in its lateral motion so that it either does not twist or twists according to a predetermined path.

The sleeve 15 about the elongate rod 13 may together be considered a coupling mechanism as this configuration couples a second stimulation component 17 to the handle 12.

Means may be utilized to store potential energy as the sleeve 15 slides forward and backward, for example, as the sleeve slides backwards towards the handle 12, for example by inserting the first stimulation component 16 into an orifice of the user such as a vagina or anus, potential energy may be stored by way of these means. For example, these means may be instantiated as a helical spring 14 that is wound about the elongate rod 13 in a concentric manner. Thus, as the sleeve 15 is pushed backwards towards the handle 12 during insertion, the helical spring 14 coils more tightly thereby storing potential energy and as the first stimulation component 16 is withdrawn from the orifice, the stored potential energy may be released and the sleeve 15 may travel forwards towards the first stimulation component 16.

The helical spring 14, and the other springs shown and described herein may be instantiated as conventional restoring mechanical springs or may be instantiated as magnetic springs that utilize magnetic repulsion to store potential energy. The magnetic spring may function by using like poles of magnets that repel each other, creating a force that may store potential energy as the stimulation end moves along the motion trajectory. This configuration may offer a more flexible and durable solution by eliminating the need for traditional coil springs and may enhance the responsiveness and smoothness of motion.

Thus, the helical spring 14, as well as comparable magnetic or elastic force restorers, may be considered to be resilient elements as they may act to return to their prior shape after being defined under mechanical stress.

The second stimulation component 17 may be fixedly connected to the sleeve 15 such that as the second stimulation component 17 moves forward and backward during insertion and withdrawal, the second stimulation component 17 moves along with it, thereby retaining a fixed position with respect to an external anatomical landmark of the user, such as a clitoris.

The second stimulation component 17 may have a stimulation end that is configured to stimulate an erogenous zone of a user, the erogenous zone being proximate to the bodily orifice. The erogenous zone may be, for example, the clitoris.

This arrangement in which the second stimulation component 17 is confined to a consistent contact area with the user's anatomy may allow for the contact surface between the stimulation end and the user's skin to remain substantially unchanged during operation, which may ensure continuous and uniform stimulation, avoiding irritation or discomfort.

The contact surface between the stimulation end and the user's skin may remain substantially unchanged during operation, which may ensure continuous and uniform stimulation, avoiding irritation or discomfort.

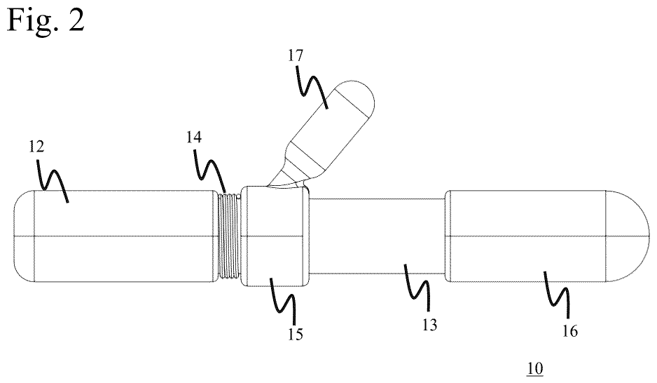

FIG. 2 is a plan view of the stimulation device 10 of FIG. 1 in a contracted state. To the extent that an element is not described in detail with respect to this or another figure, it may be understood that the element is at least similar to a corresponding element that has been described elsewhere within the present disclosure. In this state, the sleeve 15 is maximally pressed up against the handle 12 and the helical spring 14 is in a maximal state of compression storing a maximum level of potential energy. This state may be achieved by maximal insertion of the first stimulation component 16 into the bodily orifice of the user. The second stimulation component 17 maintains its fixed position relative to the orifice of the user such as to maintain contact with the clitoris throughout the entire insertion phase. In this state, as the first stimulation component 16 is withdrawn from the orifice, the second stimulation component 17, which was held in place against the external anatomy, remains in its fixed position even as the helical spring 14 relaxes and the sleeve 15 is pushed in the forward direction, toward the first stimulation component 16, by the release of the stored potential energy that is stored within the helical spring 14.

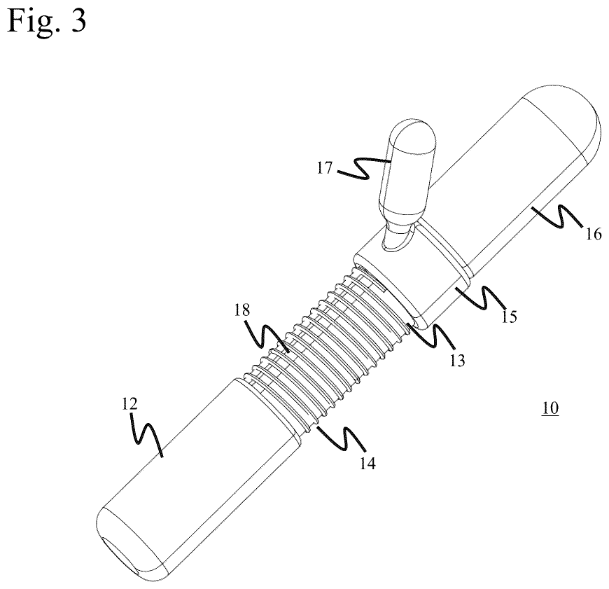

FIG. 3 is a perspective view of the stimulation device 10 in its extended state. As can be seen from this figure, there is an elongate hole 18 that is covered by the helical spring 14. A protrusion or key (not shown in this figure) extends internally from the sleeve 15 to travel within the elongate hole 18. In this way, the elongate hole guides the protrusion or key of the sleeve 15 along a predetermined path thereby limiting lateral motion. Together, the elongate hole 18 and the protrusion or key of the sleeve 15 (which may be referred to herein as a slide) form a sliding pair that is configured to define a motion trajectory of the stimulation end.

Together, the protrusion or key and the elongate hole 18 may be considered to form the sliding pair where the elongate hole 18 is considered to be the guide member and the protrusion or key of the sleeve 15 slides along the guide member along a trajectory determined by the configuration of the guide member.

Other forms of sliding pairs may be used where the guide member takes the form of a track and an element of the sleeve 15 engages with that track.

It is noted that while the elongate hole 18 is shown as being linear, the elongate hole 18 is not necessarily limited to this particular structure and may also trace a predetermined path, for example, in a serpentine shape, so that the lateral motion of the sleeve 15, and thereby the second stimulation component 17, is confined to a back-and-forth sweeping motion such as to simulate circular or elliptical motion, thereby improving the stimulation pattern.

The path of the elongate hole, or other sliding pair arrangement, may set the path of motion within three-dimensional space and may be able to produce any desired motion pattern from limiting lateral motion all together to the aforementioned serpentine track. However, according to other approaches, a planar motion may be created that may confine motion of the second stimulation component 17 to a two-dimensional plane, allowing for predictable planar motion that may simplify design and improve control.

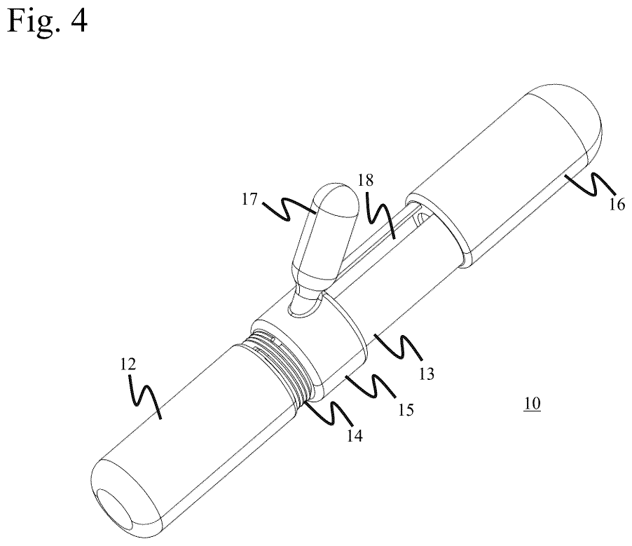

FIG. 4 is a perspective view of the stimulation device 10 in its contracted state. As can be appreciated from this figure, the elongate hole is shown as being linear.

It is noted that each of the first stimulation component 16 and the second stimulation component 17 may be outfitted with a vibrational motor that may receive electricity from conductive lines that extend through an interior of the elongate rod 13 to connect to a battery and controller that may be disposed within the handle 12. The handle 12 may also include one or more controls, such as buttons, connected to the controller for controlling the operation of the vibrational motors. The handle 12 may also include a recharging connector such as a USB port or pogo pins for allowing the battery to be recharged. The exterior of the device 10 may be covered in an impermeable skin, as will be described in more detail below.

Additionally, one or more sensors may be provided for detecting the insertion depth of the first stimulation component 16, or for detecting the sliding displacement of the second stimulation component 17 relative to the first stimulation component 16. The sensors may include, but are not necessarily limited to, at least one of an elastic sensor, a pressure sensor, or a distance sensor (e.g., a rangefinder). The sensor(s) may be in communication with the controller housed within the handle 12, such that real-time data regarding the depth of insertion or the relative motion of the components may be used to adjust operational parameters of the device, including but not limited to the vibration intensity or frequency of either or both stimulation components 16 and 17. This dynamic response may provide enhanced stimulation tailored to the user's anatomy or usage pattern, thereby improving the user's experience and increasing device versatility.

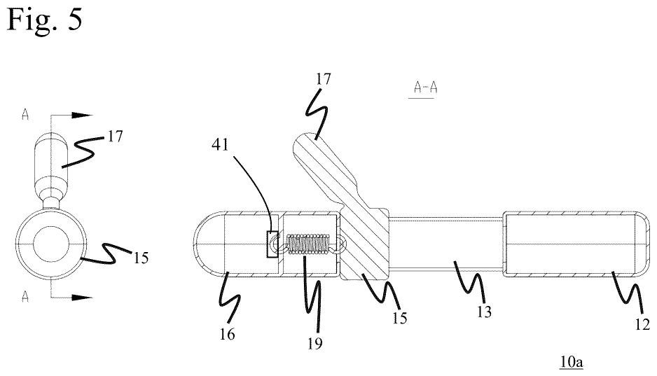

FIG. 5 is a cutaway plan view of the stimulation device 10a in an extended state, in accordance with exemplary embodiments of the present disclosure. As can be appreciated from this figure, rather than using the helical spring 14 (or in addition thereto) an internal spring 19 may connect the handle 12 to the first stimulation component 16. This internal spring 19 may be disposed within an interior of the first stimulation component 16 and may also run within an interior of the elongate rod 13 as well. The internal spring 19 may connect to an interior of the sleeve 15, for example, through the elongate hole 18 which is not depicted in this figure. Another means of attachment may be used and exemplary embodiments of the present disclosure are not necessarily limited to the illustrated arrangement.

Additionally, one end of the internal spring 19 may be provided with an elastic sensor 41 configured to detect variations in tensile force as the internal spring 19 is stretched. This sensor 41 may transmit force data to a control circuit disposed within the handle 12, which in turn dynamically adjusts the operational behavior of one or more vibrational motors within the device. For example, the vibrational motor within the first stimulation component 16 may increase or decrease its vibration intensity in real time based on the detected spring force, which correlates to the degree of insertion or the first stimulation component 16 or pressure exerted by the sleeve 15. Similarly, the vibrational motor disposed within the second stimulation component 17 may also vary in intensity according to the movement of the sleeve 15. In one illustrative use case, when the first stimulation component 16 is inserted into a bodily orifice (such as a vagina), the internal spring 19 stretches, triggering a change in the tension data sensed by the elastic sensor 41. In response, the controller may increase the vibration intensity of the motor in the second stimulation component 17, thereby enhancing stimulation of an external erogenous zone (e.g., the clitoris). This feedback-controlled mechanism enables real-time physiological response-based stimulation adjustments.

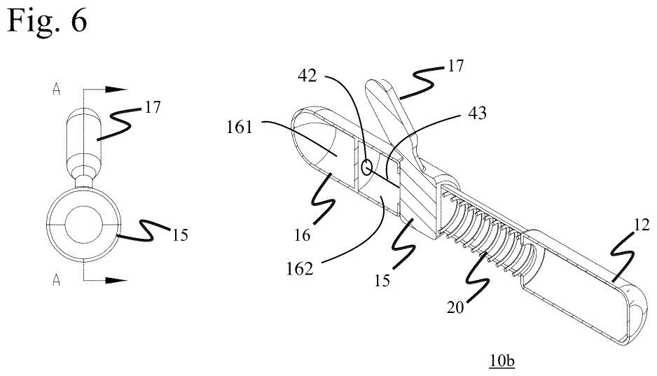

FIG. 6 is a cutaway perspective view of a stimulation device 10b in an extended state in accordance with exemplary embodiments of the present disclosure. As can be appreciated from this figure, rather than using a helical spring 14 or an internal spring 19 (or in addition thereto) an interior spring 20 may be disposed within the elongate rod 13 seated against the handle 12 on one side thereof, and seated against the sleeve 15 on an opposite side thereof. Thus, as the sleeve is pushed backward towards the handle 12, tension is built in the interior spring 20 so that it may recall during withdrawal of the device so as to keep the second stimulation component 17 in its relatively fixed position with respect to the exterior anatomy of the user.

Additionally, the interior of the second stimulation component 16 may be divided into a first chamber 161 and a second chamber 162. The first chamber 161 may be configured to accommodate a vibrational motor. The second chamber 162 may be configured to house a distance sensor, such as a laser rangefinder 42.

The laser rangefinder 42 may be a semiconductor diode laser that may produce for example, a light beam 43 of red light within a range of approximately 630-670 nm using an aluminum gallium indium phosphide (AlGaInP) laser diode.

The laser rangefinder 42 may be configured to emit a laser beam 43 toward the sleeve 15, and detect the reflected signal therefrom to measure the distance that the sleeve 15 has slid relative to the second stimulation component 17. Thus, the laser rangefinder 43 forms the basis of a laser distance meter.

This measured displacement may be used to infer the relative position of the sleeve 15 along the elongate rod 13. The output from the rangefinder 42 may be transmitted to the controller within the handle 12, where it can be used to adjust the vibration parameters of either stimulation component dynamically. In this way, the device can autonomously enhance or reduce stimulation intensity based on actual positional feedback, further improving the responsiveness and adaptability of the stimulation experience.

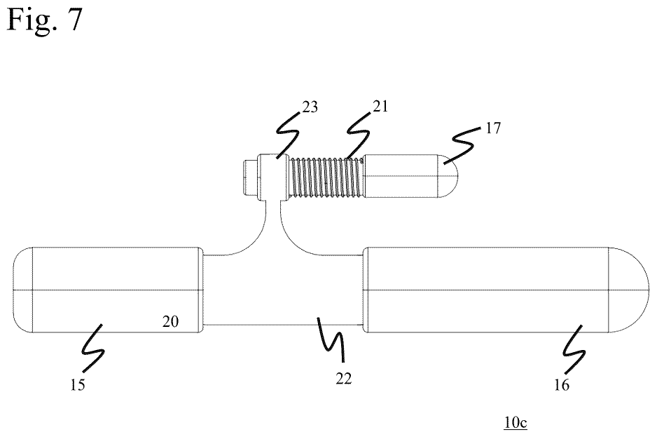

FIG. 7 is a plan view of a stimulation device 10c in an extended state in accordance with exemplary embodiments of the present disclosure. As can be appreciated from this figure, rather than using a helical spring 14, an internal spring, or an interior spring 20, (or in addition thereto) here a second stimulation component spring 21 is used. According to this arrangement, the handle 12 is fixedly connected to the first stimulation component 16 via a bridge 22. An arm 23 extends from the bridge 22 and the arm 23 may wrap around a shaft of the second stimulation component 17 with the second stimulation component spring 21 fixed to the arm 23 on one side and to the second stimulation component 17 on the other side. During insertion, the second stimulation component 17 is pressed and the shaft thereof slides within the arm 23 to compress the second stimulation component spring 21 to maintain the relative position of the second stimulation component 17. Such an arrangement may be referred to herein as matched trajectories as the spring is used to have the second stimulation component 17 match the trajectory of the first stimulation component 16.

It is noted that the shaft of the second stimulation component 17 may include an elongate hole similar to that previously discussed and the arm 23 may have a protrusion or key that inserts into this elongate hole for a similar implementation as discussed above so that lateral movement of the second stimulation component 17 may be confined in the manner discussed above.

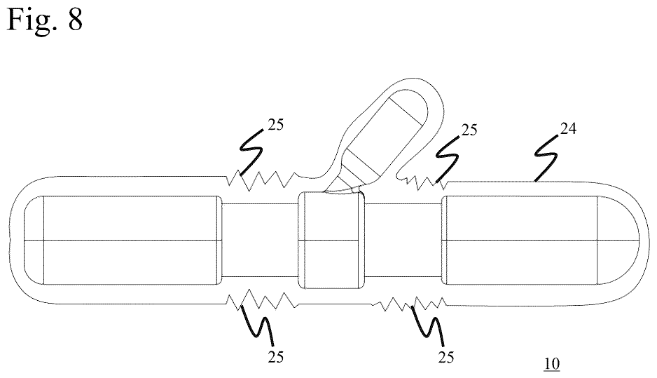

FIG. 8 is a plan view of a stimulation device 10 in an intermediate state, in accordance with an exemplary embodiment of the present disclosure. This figure is said to show an intermediate state as the sleeve 15 is disposed between the handle 12 and the first stimulation component 16. A flexible covering 24 is shown as being disposed around the device 10 including around the handle 12, the sleeve 15, the first stimulation component 16 and the second stimulation component 17. The flexible covering 24 is shown to have elastic regions 25, such as folds or bellows to allow for the sleeve 15 and second stimulation component 17 to move freely about the elongate rod 13. The flexible covering 24 may include an impermeable and elastic material such as silicone rubber, elastomeric polymers, or a urethane-based material. The aforementioned charging port may be exposed through an opening in the flexible covering 24 at the handle 12.

The flexible covering may take on the role of the springs described herein and may thus provide the restoring force needed to return the sleeve 15 and the second stimulation component 17 to the contracted state after being forced into the extended state during insertion. Alternatively, one or more springs (mechanical or magnetic) may still be used.

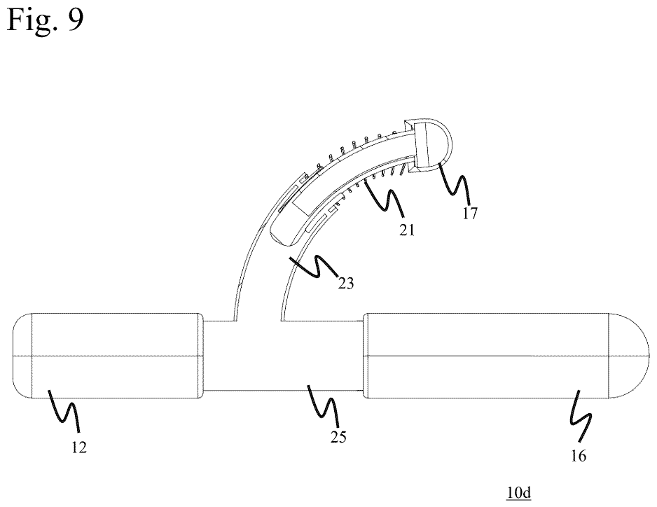

FIG. 9 is a plan view of a stimulation device 10d in an extended state in accordance with exemplary embodiments of the present disclosure. This structure depicts another matched trajectory arrangement. As can be appreciated from this figure, the handle 12 is fixedly connected to the first stimulation component 16 by a bridge 25 and an arm 23 extends from the bridge in an arc shape. Here, rather than the arm 23 forming a ring around the shaft of the second stimulation component 17, as shown in FIG. 7, the shaft of the second stimulation component 17 is also arc shaped and is received within the arm 23. A second stimulation component spring 21 may be used here between the second stimulation component 17 and the arm 23 so as to store potential energy that may be released to maintain the relative position of the second stimulation component 17.

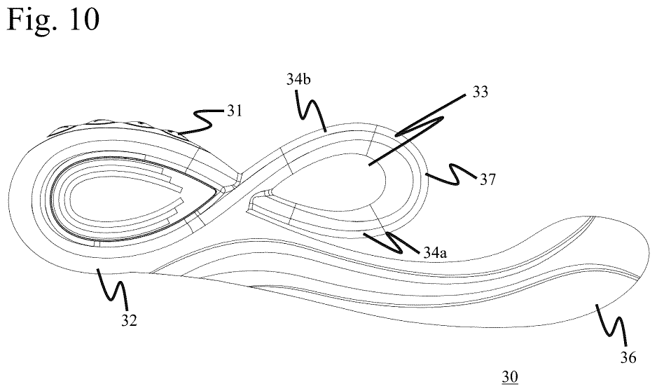

FIG. 10 is a plan view of a stimulation device 30 having an alternative coupling mechanism in accordance with exemplary embodiments of the present disclosure. As can be appreciated from this figure, the stimulation device 30 includes a handle 32 and a first stimulation component 36 that extends therefrom. The handle 32 may include various controls 31, displays, and charging ports and extending from either the handle portion 32 or the first stimulation component 36 may be a second stimulation component 37 that is connected to the device 30 by one or more elastic connectors, here depicted as a first elastic connector 34a and a second elastic connector 34b.

Thus, as the first stimulation component 36 is inserted into the orifice, the second stimulation component 37 presses against the exterior of the orifice and the elastic connectors 34a and 34b give way as they store potential energy. Then, as the first stimulation component 36 is withdrawn, the elastic connectors 34a and 34b restore and the second stimulation component 37 is able to maintain its relative position.

In this arrangement, the handle 32 may have a bulbus shape that flows seamlessly into the elastic connectors 34a and 34b so as to form a loop with the second stimulation component 37. The center of the loop may be an annular space 33 that is open. Thus, when the elastic connector 34a and 34b are in their contracted state, they may bend outwardly, inwardly into the annular space 33, or may internally compress. The structure of the elastic connectors 34a and 34b may itself provide the required level of elasticity and restorative force while also maintaining the structural integrity of the device. The elastic connectors 34a and 34b may be substantially tubular and conductive wires or other connectors may bring electricity from a battery disposed within the handle 32 to a vibrational motor within the second stimulation component 37 through the tubular center of the elastic connectors 34a and 34b.

While the stimulation device 30 depicted in FIG. 10 may rely upon the elastic structure of the elastic connectors 34a and 34b to provide the restorative force, alternatively, springs, either mechanical or magnetic, may be used within an elastic skin to achieve a comparable result. By employing a pair of elastic connectors 34a and 34b rather than a single bendable connector, the second stimulation component 37 may be able to better maintain its position regardless of how the stimulation device 30 is angled during insertion and withdrawal.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

1. A sexual stimulation device, comprising:
a main body;
a first stimulation component extended from a bottom portion of the main body and configured to be inserted into a bodily orifice;
a second stimulation component having a stimulation end configured to stimulate an erogenous zone that is proximate to the bodily orifice; and
a coupling configured to couple the second stimulation component to the bottom portion, the coupling including:
a slide assembly configured to constrain the movement of the stimulation end; and
a spring configured to store or release potential energy as the stimulation end moves, such that the stimulation end maintains continuous contact with the erogenous zone as the first stimulation component reciprocates within the bodily orifice,
wherein the slide assembly comprises:
a guide including at least a portion of the main body and configured to constrain the movement of a slide along an axis of the guide; and
the slide, coupled to the second stimulation component and configured to slide in accordance with the constraints of the guide,
wherein the guide comprises an elongate rod, wherein the slide comprises a sleeve accommodated about the elongate rod, and wherein the sleeve is connected to the second stimulation component, and
wherein the spring is a helical spring wound about the elongate rod, with opposite ends of the helical spring respectively connected to the sleeve and the bottom portion of the main body.

2. The sexual stimulation device according to claim 1, wherein the stimulation end is constrained to move in a first direction while maintaining continuous contact with the erogenous zone when the first stimulation component is inserted into the bodily orifice, thereby causing the spring to store potential energy, and
wherein the stimulation end is constrained to move in a second direction, opposite to the first direction, when the first stimulation component is withdrawn from the bodily orifice by the release of the stored potential energy from the spring, thereby maintaining continuous contact between the stimulation end and the erogenous zone.

3. The sexual stimulation device according to claim 1, wherein the coupling further comprises a flexible covering, at least a portion of the flexible covering forming an elastic region, and wherein the spring is defined by the elastic region.

4. (canceled)

5. The sexual stimulation device according to claim 1, wherein the slide assembly is disposed within the main body or within the second stimulation component.

6-7. (canceled)

8. The sexual stimulation device according to claim 1, wherein the guide comprises an elongate hole formed on the main body, and the slide comprises a protrusion extending through the elongate hole.

9. The sexual stimulation device according to claim 8, wherein the spring comprises a helical spring disposed within the main body, with opposite ends of the helical spring respectively connected to the protrusion and the main body.

10. A sexual stimulation device, comprising:
a main body;
a first stimulation component extended from a bottom portion of the main body and configured to be inserted into a bodily orifice;
a second stimulation component having a stimulation end configured to stimulate an erogenous zone that is proximate to the bodily orifice; and
a coupling configured to couple the second stimulation component to the bottom portion, the coupling including:
a slide assembly configured to constrain the movement of the stimulation end; and
a spring configured to store or release potential energy as the stimulation end moves, such that the stimulation end maintains continuous contact with the erogenous zone as the first stimulation component reciprocates within the bodily orifice,
wherein the slide assembly comprises:
a guide including at least a portion of the main body and configured to constrain the movement of a slide along an axis of the guide; and
the slide, coupled to the second stimulation component and configured to slide in accordance with the constraints of the guide,
wherein the guide comprises an elongate groove, and the slide is engaged within the elongate groove.

11. The sexual stimulation device according to claim 1, wherein the stimulation end is constrained to move in reciprocation the first stimulation component is coupled to the stimulation end to also be constrained to move in reciprocation.

12. The sexual stimulation device according to claim 1, wherein the guide comprises a sleeve, the slide comprises an elongate rod about which the sleeve is circumscribed, and wherein the elongate rod is connected to the second stimulation component.

13. The sexual stimulation device according to claim 1, wherein the slide assembly is curved, and the stimulation end is constrained to move in an arcuate trajectory.

14. The sexual stimulation device according to claim 1, wherein the stimulation end is constrained to move along a substantially two-dimensional plane.

15. The sexual stimulation device according to claim 1, wherein a relative distance between the stimulation end and the erogenous zone remains substantially unchanged as the first stimulation component reciprocates within the bodily orifice.

16. A sexual stimulation device, comprising:
a main body including a handle and a first stimulation component, the first stimulation component configured to be inserted into a bodily orifice;
a second stimulation component having a stimulation end configured to provide sexual stimulation to an erogenous zone that is proximate to the bodily orifice;
a coupling configured to couple the second stimulation component to the main body;
a slide assembly configured to constrain the movement of the stimulation end; and
a spring configured to store or release elastic potential energy as the stimulation end moves, such that the stimulation end maintains continuous contact with the erogenous zone as the first stimulation component reciprocates within the bodily orifice,
wherein the slide assembly comprises:
a guide including at least a portion of the coupling; and
a slide including at least a portion of the second stimulation component, the slide configured to slide along the constrained movement of the stimulation end.

17. (canceled)

18. The sexual stimulation device according to claim 16, wherein the guide comprises a sleeve including at least a portion of the coupling, wherein the slide comprises an elongate rod formed by at least a portion of the second stimulation component, and wherein the elongate rod passes through the sleeve.

19. The sexual stimulation device according to claim 16, wherein the movement of the stimulation end is constrained to move in parallel to the reciprocation of the first stimulation component.

20. (canceled)
